(19) United States
(12) Patent Application Publication
(10) Pub. No.: US 2011/0233130 A1
(43) Pub. Date: Sep. 29, 2011

(54) METHOD AND ARRANGEMENT FOR FIXING AN ENDLESS WIRE

(75) Inventor: David Lindkvist, Alnö (SE)

(73) Assignee: METSO PAPER, INC., Helsinki (FI)

(21) Appl. No.: 13/131,382

(22) PCT Filed: Dec. 9, 2009
(86) PCT No.: PCT/SE2009/051394

§ 371 Date: May 26, 2011

(30) Foreign Application Priority Data
Dec. 19, 2008 (SE) 0802633-8

(51) Int. Cl. B01D 29/00; B23P 17/04

(52) U.S. Cl. 210/348; 29/428

(57) ABSTRACT

The invention relates to a method and an arrangement for fixing an endless wire (2) to a cylindrical drum (1). The endless wire (2) is shrunk around the whole circumference of the cylindrical drum (1), such that the edge portions (3) of the endless wire (2) are located near the edge sections (4) of the cylindrical drum. The shrunk endless wire (2) has a length that makes it fit tightly around said drum (1). At least two strips (5) of a shrinkable material have been shrunk around the edge portions (3) of the endless wire (2) that is arranged on the cylindrical drum (1), such that they form endless strips (5) for holding the edge portions (3) of the endless wire (2) fixed around the whole circumference of the cylindrical drum (1). The shrunk strips (5) also have a length that make them fit tightly around said drum and such that they assist in keeping the edge portions (3) of the endless wire (2) fixed around the cylindrical drum (1).

### TECHNICAL FIELD

The invention generally relates to endless wires and specifically to a method and an arrangement for fixing an endless wire around a drum with a perforated outer surface.

### BACKGROUND

In some applications in the pulp industry endless wires are attached round a cylindrical perforated drum. One such application is filtering drums, wherein filtrate from a washing or dewatering process is filtered in order to extract useful cellulose fibres from the filtrate. The wording “endless wire” implies that it has no end in the circumferential direction; however, in the axial direction the wire has two (axial) edges.

In the use of filtering drums the liquid to be filtered, e.g. wash liquid, is filtered through the endless wire and through the perforated outer surface of the drum, such that the fibres in the liquid are extracted and stays on the surface of the endless wire, wherein the resulting filtrate is drained into a hollow part of the drum and is subsequently discarded as waste water or passed onto a subsequent processing step.

The fibres obtained in the filtering stage may be re-entered into further processing steps of the pulp process.

In use, the endless wire is exposed to various forces acting in various directions of the wire. These forces tend to move the wire out of position, and therefore, in order to prevent such movements the wire needs to be fixed to the drum. It is favourable that an arrangement for fixing the wire includes a fixing means for fixing the edge portions of the endless wire.

### PRIOR ART

In FIG. 2, a conventional arrangement for fixing the edge portions of an endless wire to the edge section of a cylindrical drum 1 is shown. The endless wire has been shrunk to fit the drum 1. A metal strip 20 is arranged around the endless wire and the drum 1 by means of a fastening arrangement in form of a screw joint reinforcement 21 including a screw 22 and two bolts 23. Two holding parts 24 of the fastening arrangement are welded on to each end of the metal strip 20, such that the metal strip 20 may be tightened around the endless wire and the drum by actuation of the screw 22 and the bolts 23. This is, however, a rather complicated and expensive arrangement. Also, the edges of the metal strip may damage the endless wire, such that it will have to be replaced and prematurely discarded. Another problem is that the screw joint is rather bulky and precaution has to be taken not to disturb its passage during rotation of the drum.

Another way of fastening an endless wire is presented in EP 0 341 913 B1, in which the endless wire is provided with guide belts, which are fastened to the edge portions of the wire. Thus, the guide belts function as guides, guiding the wire along its path. This is a functional solution for wires that pass between several drums. However, it is expensive and would be complicated to implement on a single drum, since at least one of the guide belts would have to be fastened to the wire when the wire has already been placed around the drum.

Hence, there is a need for a fastening arrangement for fastening an endless wire to a single drum, which arrangement is easy to implement and not too expensive to produce.

### SUMMARY OF THE INVENTION

The object of the invention is to provide a novel, functional and easily implemented method and arrangement for fixing an endless wire to a drum.

According to a first aspect, the invention relates to a method of fixing an endless wire to a cylindrical drum, the method including the steps of:
providing a wire of a shrinkable material, which wire has a length that corresponds to, or is slightly longer than, the circumference of a cylindrical drum;
applying said wire around the cylindrical drum, such that it forms an endless wire around the whole circumference of the cylindrical drum, and such that the edge portions of the thus formed endless wire are located near the edge sections of the cylindrical drum;
shrinking the wire on location around the cylindrical drum, such that it obtains a length that makes it fit tightly around said drum. Further the method includes the steps of:
providing at least two strips of a shrinkable material, both strips having a length that corresponds to, or is slightly longer than, the circumference of the cylindrical drum;
applying said strips around the edge portions of the endless wire arranged on the cylindrical drum, such that they form endless strips for holding the edge portions of the endless wire fixed around the whole circumference of the cylindrical drum;
shrinking the strips on location around the endless wire arranged on the cylindrical drum, such that they obtain a length that make them fit tightly around said drum and such that they assist in keeping the edge sections of the endless wire fixed.

According to a second aspect the invention relates to an arrangement for fixing an endless wire to a cylindrical drum, which arrangement includes:
a cylindrical drum;
a wire of a shrinkable material, said wire having been shrunk around the cylindrical drum to form an endless wire around the whole circumference of the cylindrical drum, the edge portions of the endless wire being located near the edge sections of the cylindrical drum;
the shrunk endless wire having a length that makes it fit tightly around said drum. Further, the arrangement includes:
at least two strips of a shrinkable material, said strips having been shrunk around the edge sections of the endless wire arranged on the cylindrical drum, such that they form endless strips for holding the edge sections of the endless wire fixed around the whole circumference of the cylindrical drum;
the shrunk strips having a length that make them fit tightly around said drum and such that they assist in keeping the edge sections of the endless wire fixed.

The invention provides a method and an arrangement for fixing an endless wire to a cylindrical drum that is easy to implement and execute, and that is both cost efficient and reliable. Regarding all these aspects the invention provides advantages with respect to the prior art.

Advantageous embodiments of the invention will become apparent from the dependent claims and from the detailed description of the invention.

### SHORT DESCRIPTION OF THE DRAWINGS

Below, the invention will be described in detail with reference to the accompanying drawings, of which:

FIG. 1 shows a drum on which an endless wire is arranged;

FIG. 2 shows a conventional method of fastening an endless wire to a drum; and

FIG. 3 shows a longitudinal section of an edge section of a drum, where an endless strip is arranged around the edge portion of the endless wire on said drum.

### DETAILED DESCRIPTION OF THE INVENTION

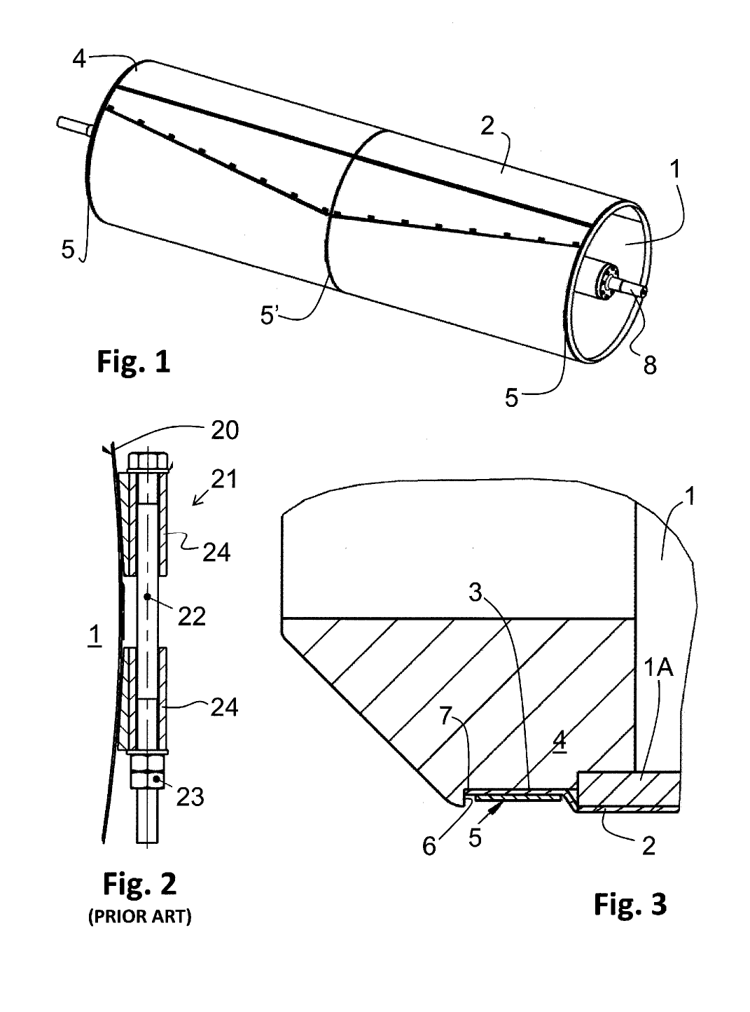

FIG. 1 shows a cylindrical drum 1, around which an endless wire 2 is arranged. The endless wire is produced from a wire of a shrinkable material, which has been shrunk around the cylindrical drum 1, such that it forms an endless wire around the whole circumference of the cylindrical drum. The length of the endless wire 2 is such that when it has been shrunk it fits tightly around the drum 1, and the width of it is such that its edge portions 3 are located at an edge section 4 of the cylindrical drum 1. Normally, the width of the wire 2, i.e. its extension along the axial direction of the drum, is over dimensioned such that parts of the wire will extend outside the axial length of the drum 1. The superfluous material of the wire 2 is normally removed, e.g. by cutting. The cutting is however preferably performed after that edge portions 3 of the wire 2 has been fixed.

A main portion of the outer surface of the cylindrical drum 1 is perforated and the wire is arranged such that it covers at least this perforated portion of the drum. During filtration, the liquid to be filtered passes through the endless wire 2 and through the perforations of the drum 1. The inside of the drum involves ducts for leading away the filtrate to disposal or to further processes. The filtride, i.e. the solid portions that are obtained from the filtration, adheres to the outer surface of the wire 2 and may be gathered, e.g. by means of a water jet, a doctor blade or the like. When a doctor blade is used, precaution has to be taken in order not to damage the wire 2.

As indicated in the background portion of the description the endless wire 2 needs to be tightly fastened to the drum 1 in order for the filtering process to work properly and be fully efficient.

In FIG. 3, a longitudinal section of the lower left edge section 4 of a drum 1 is shown, wherein an endless strip 5 is arranged around the edge portion 3 of the endless wire 2 on said drum 1. The outer surface 1A of the drum 1 is perforated (not shown) in order to let filtrate pass through the wire 2 and said outer surface 1A into a hollow part of the drum 1. The perforated outer surface 1A covers substantially the whole circumferential length of the drum 1 between the respective edge sections 4 of the drum 1.

The edge section 4 of the shown embodiment is formed as an individual part of the cylindrical drum 1 and includes a circumferential recess 6 of a width that corresponds to the width of an endless strip 5. The edge portions 3 of the endless wire 2, as well as the endless strips 5 are at least partly shrunk into said recesses 6, in order to fix the edge sections 4 of the endless wire 2. The rims 7 of the endless wire 2 may extend outside the respective recesses 6. Also, each rim 7 may involve a bulge in the form of a seam or the like, which bulge is prevented from slipping under the strips 5 due to its own thickness. Normally this is however not needed since the friction between the wire 2 and the strip 5 is sufficient from keeping them from moving with respect to each other.

The thickness of the endless strips 5 is preferably greater than the thickness of the endless wire 2, even though they may be made from the same fabric. For instance, the endless wire 2 may consist of a single fabric layer, whereas the endless strips 5 may consist of multiple fabric layers, preferably a double fabric layer.

In this arrangement at least two strips 5 of a shrinkable material, similar to the material of the endless wire 2 itself, have been shrunk around the edge portions 3 of the endless wire 2, once the wire has already been arranged on the cylindrical drum 1, such that they form endless strips 5 for holding the edge portions 3 of the endless wire 2 fixed to the respective edge sections 4 the cylindrical drum 1. If a very wide drum 1 is to be covered by a single endless wire 2, it may be advantageous to use more than two strips 5 for fastening it to the drum, for example a strip 5′ may be used to fix the centre of the endless wire 2.

The shrunk strips 5 have a length that make them fit tightly around said drum and that assist in keeping the edge portions 3 of the endless wire 2 fixed. Preferably, the strips 5 are prefabricated in the desired lengths, but they may also be cut into usable lengths at location. An advantage with strips 5 that have been prefabricated into usable lengths is that they may be provided with seams for facilitating the connection of the circumferential ends thereof to each other.

The method of fixing the endless wire is done in steps. Firstly a wire of a shrinkable material has to be provided. The wire should have a length that corresponds to, or is slightly longer than, the circumference of a cylindrical drum. The wire should then be applied around the cylindrical drum 1, such that it forms an endless wire 2 around the whole circumference of the cylindrical drum, and such that the edge portions 3 of the thus formed endless wire 2 are located near the edge sections 4 of the cylindrical drum 1.

Thereafter, the wire is shrunk on location around the cylindrical drum, such that it obtains a length that makes it fit tightly around said drum. In order to fix the endless wire 2 sufficiently, at least two strips 5 of a shrinkable material, possibly the same material as that of the endless wire 2, are provided. Both these strips 5 should have a length that corresponds to or is slightly longer than the circumference of the cylindrical drum 1. The strips are then applied around the edge sections of the endless wire 2, already arranged on the cylindrical drum 1, such that they form endless strips 5 for holding the edge portions 3 of the endless wire 2 fixed around the whole circumference of the cylindrical drum 1.

The strips 5 are then shrunk on location around the endless wire 2 and the cylindrical drum 1, such that they obtain a length that make them fit tightly around said drum and that assist in keeping the edge portions 3 of the endless wire 2 fixed to it.

Preferably, when the wire is applied around the cylindrical drum 1 the circumferential edge portions 3 of the wire are sewn together, in order to form the endless wire 2. The strips 5 may be applied in the same manner, i.e. by sewing the short ends of the strips together. Preferably these steps are performed on location around the drum 1, since it may not be feasible to apply the wire 2 nor the strips 5 once their ends are sewn together, and since the axial ends 8 of the drum 1 are carried in bearings (not shown).

The shrinking of the endless wire 2 and the endless strips 5 are preferably performed by applying hot water to the shrinkable material. Possibly it may be done in steps, where a portion of the drum, typically a sixth of the drum, is located in a bath of hot water long enough to shrink the wetted portion of the wire/strips. Another way of performing the shrinking is by adding steam to the fabric. This may be advantageous, at least for shrinking the strips 5, since these have a limited extension in the axial direction, such that the whole width of the strips 5 may be simultaneously processed by a single steaming apparatus.

Preferably, the endless wire 2 is shrunk in a first step and the endless strips 5 are shrunk in a second step.

Above, the invention has been described with reference to specific embodiments; however, the invention is not limited to any of these specific embodiments. Instead, the invention is only limited by the scope of the following claims.

1. A method of fixing an endless wire to a cylindrical drum, the method including the steps of:
providing a wire of a shrinkable material, which wire has a length that corresponds to, or is slightly longer than, the circumference of said cylindrical drum;
applying said wire around said cylindrical drum, such that it forms an endless wire around the whole circumference of said cylindrical drum, and such that the edge portions of the thus formed endless wire are located near the edge sections of said cylindrical drum;
shrinking said endless wire around said cylindrical drum, such that it obtains a length that makes it fit tightly around said cylindrical drum;
providing at least two strips of a shrinkable material, each of said at least two strips having a length that corresponds to, or is slightly longer than, the circumference of said cylindrical drum;
applying said at least two strips around said edge portions of said endless wire arranged on said cylindrical drum, such that they form endless strips for holding said edge portions of said endless wire fixed around the whole circumference of the said cylindrical drum; and
shrinking said strips on location around said endless wire arranged on said cylindrical drum, such that they fit tightly around said cylindrical drum and such that they assist in keeping said edge portions of said endless wire fixed thereto.

2. The method according to claim 1, wherein said step of applying said wire around said cylindrical drum includes sewing circumferential edge portions of said wire together, to form said endless wire around said cylindrical drum.

3. The method according to claim 1, wherein said step of applying said at least two strips around said cylindrical drum includes sewing opposed circumferential edge portions of each of said at least two strips together, such that at least two individual endless strips are formed.

4. The method according to claim 1, wherein said steps of shrinking said endless wire and said endless strip are performed by applying hot water or steam to the respective shrinkable material.

5. The method according to claim 4, wherein said shrinking step is performed in at least separate two steps, including a first step where only said endless wire is shrunk around said cylindrical drum, and a second subsequent step where said endless strips are shrunk around said wire.

6. The method according to claim 5, wherein a third strip is applied and shrunk around a central portion of said endless wire (2).

7. Apparatus including:
a cylindrical drum with a perforated outer surface;
an endless wire of a shrinkable material, said endless wire having been shrunk around said cylindrical drum such that it forms an endless wire around the whole circumference of said cylindrical drum, the edge portions of said endless wire being located near the edge sections of said cylindrical drum;
said shrunk endless wire having a length that makes it fit tightly around said cylindrical drum;
at least two endless strips of a shrinkable material, said at least two endless strips having been shrunk around the edge portions of said endless wire arranged on said cylindrical drum, such that they form endless strips for holding said edge portions of said endless wire fixed around the whole circumference of said cylindrical drum; and
said shrunk strips having a length that make them fit tightly around said cylindrical drum and such that they keep said edge portions of said endless wire fixed.

8. The apparatus according to claim 7, wherein said respective edge sections of said cylindrical drum includes a recess of a width that corresponds to the width of said endless strip, and wherein said respective edge portions of said endless wire as well as said respective endless strips are at least partly shrunk into said recesses, in order to fix said edge portions of said endless wire (2) in said recess.

9. The apparatus according to claim 7, wherein the thickness of said endless strips is greater than the thickness of said endless wire.

10. The apparatus according to claim 9, wherein said endless strips comprise multiple layers of fabric.

11. The arrangement according to claim 7, wherein said longitudinal ends of said endless strips include a prearranged seam for joining said longitudinal ends to each other.

12. The apparatus according to claim 10 wherein said multiple layers of fabric comprise a double fabric layer.
